(19) United States
(12) Patent Application Publication
(10) Pub. No.: US 2007/0220959 A1
(43) Pub. Date: Sep. 27, 2007

(54) Novel ultrananocrystalline diamond probes for high-resolution low-wear nanolithographic techniques

(75) Inventors: Anirudha V. Sumant, Downers Grove, IL (US); Robert W. Carpick, Madison, WI (US); Orlando H. Auciello, Bolingbrook, IL (US); John A. Carlisle, Plainfield, IL (US)

Correspondence Address: Harry M. Levy, Esq.;Emrich & Dithmar, LLC., 20 North Wacker Drive, 36th Floor, Chicago, IL, 60606, US

(73) Assignee: UChicago Argonne LLC, Chicago, IL (US)

(21) Appl. No.: 11/542,812

(22) Filed: Oct. 4, 2006

Related U.S. Application Data
(63) Continuation of application No. 11/388,636, filed on Mar. 24, 2006, now abandoned.

(51) Int. Cl. G01B 5/28

(52) U.S. Cl. 73/105

(57) ABSTRACT

A monolithically integrated 3-D membrane or diaphragm/tip (called 3-D tip) of substantially all UNCD having a tip with a radius of about less than 50 nm capable of measuring forces in all three dimensions or being used as single tips or in large arrays for imprint of data on memory media, fabrication of nanodots of different materials on different substrates and many other uses such as nanolithography production of nanodots of biomaterials on substrates, etc. A method of molding UNCD is disclosed including providing a substrate with a predetermined pattern and depositing an oxide layer prior to depositing a carbide-forming metallic seed layer, followed by seeding with diamond nano or micropowder in solvent suspension, or mechanically polishing with diamond powder, or any other seeding method, followed by UNCD film growth conforming to the predetermined pattern. Thereafter, one or more steps of masking and/or etching and/or coating and/or selective removal and/or patterning and/or electroforming and/or lapping and/or polishing are used in any combination to form the tip or probe.

### RELATED APPLICATIONS

This application is a continuation of application Ser. No. 11/388,636 filed Mar. 24, 2006.

### CONTRACTUAL ORIGIN OF THE INVENTION

The United States Government has rights in this invention pursuant to Contract No. W-31-109-ENG-38 between the U.S. Department of Energy and UChicago Argonne LLC representing Argonne National Laboratory.

### FIELD OF THE INVENTION

This invention relates to molding ultrananocrystalline diamond (UNCD) and particularly three dimensional probes used in atomic force microscopy (AFM).

### BACKGROUND OF THE INVENTION

The sensing of small forces in a reliable and accurate manner is a key scientific and technological capability being harnessed across many scientific disciplines and in many industries. This is accomplished using atomic force microscopy (AFM) in applications such as topographic imaging, metrology, nanomachining, nanolithography, nanomanufacturing, nanoscale data storage, nanotribology measurements, and nanomechanical characterization experiments. However, AFM, which utilizes probes consisting of micro cantilevers with integrated nano-scale tips generally made of Si or other materials with relatively low hardness and high coefficient of friction, have two main drawbacks. First, the probes suffer from wear, degradation, and contamination too easily. This limits the lifetime, accuracy, and reproducibility of AFM measurements. Second, the nature of the probe's structure itself, a simple fixed-free beam that must be tilted at an angle so that the tip touches the surface first, has several disadvantages structurally, namely: (1) the micro cantilever is difficult to calibrate accurately; (2) the tilt introduces coupling between normal and in-plane forces, rendering mechanical measurements subject to uncertainty and error; and (3) forces are only measured along two axes, namely the vertical direction and the lateral direction (i.e. in-plane, perpendicular to the long axis of the cantilever), but forces in the longitudinal direction (i.e. in-plane, parallel to the long axis of the cantilever) are coupled into the normal force signal.

A number of scanning probe techniques have been developed in recent years. These techniques require sophisticated probes, such as those employed in nanolithography, arrays for parallel imaging, writing, and data reading/recording, or even more complex tasks such as drilling, cutting, or milling. The cost of these specialized probes and their functional life, in terms of scanning distance, are strongly competing parameters in their design. Engineering new materials and developing simple fabrication processes is one way of addressing this problem. The lifetime of probes is typically shortened by mechanical failure in operation and handling, pickup of material and particles from the samples, and wear. The former can be enhanced by more careful procedures, but the latter is especially important in contact mode techniques, such as contact-mode AFM imaging, see E. Meyer, H. J. Hug, R. Bennewitz, Scanning Probe Microscopy: The Lab on a Tip, Springer, Berlin, 2004; R. P. Lu, K. L. Kavanagh, St. J. Dixon-Warren, A. J. Spring Thorpe, R. Streater, I. Calder, J. Vac. Sci. Technol. B 2002, 20, 1682-1689; M. C. Hersam, A. C. F. Hoole, S. J. O'Shea, M. E. Welland, Appl. Phys. Lett. 1998, 72, 915-917; Veeco, Application Modules: Dimension and MultiMode Manual, Chap. 2, 2003; and A. S. Basu, S. McNamara, Y. B. Gianchandani, J. Vac. Sci. Technol. B 2004, 22, 3217-3220, and incorporated by reference, scanning spreading resistance microscopy, atomic-scale potentiometry, scanning thermal microscopy, and lithography, such as dip-pen and fountain-pen nanolithography; see also R. D. Piner, J. Zhu, F. Xu, S. Hong, C. A. Mirkin, Science 1999, 283, 661-663; P. E. Sheehan, L. J. Whitman, W. P. King, B. A. Nelson, Appl. Phys. Lett. 2004, 85, 1589-1591; Y. Li, B. W. Maynor, J. Liu, J. Am. Chem. Soc. 2001, 123, 2105-2106; J. Jang, S. Hong, G. C. Schatz, M. A. Ratner, J. Chem. Phys. 2001, 115, 2721-2729 and K.-H. Kim, N. Moldovan, H. D. Espinosa, Small 2005, 1, 632-635, incorporated by reference.

Hard materials are typically employed to reduce probe wear, among which diamond is the obvious material of choice. Furthermore, diamond possesses surface and bulk properties that are ideal for probes: very low chemical reactivity, a low work function when the surface is chemically conditioned, low coefficient of friction, no oxide layer formation, tunable electrical conductibility by doping, and thermal conductivity ranging from relatively low (˜10 WK⁻¹m⁻¹) for ultra-nanocrystalline diamond (UNCD) to extremely high (˜2000 WK⁻¹m⁻¹) for single-crystal diamond. As used herein, UNCD is nanocrystalline diamond having average grain diameters in the range of from about 2 to about 5 nm. Preferably, but not necessarily, at least 95% of the diamond is UNCD. Preparation of UNCD is now well known in the art.

In previous work, several species of diamond films have been employed in probe fabrication by different groups, which vary mainly in the degree of crystallinity of the diamond. Initial attempts at producing conductive diamond probes for scanning tunneling microscopy involved boron implanted macroscopic diamond crystals, which were machined by polishing and mechanically assembled into AFM cantilevers, see R. Rameshan, Thin Solid Films 1999, 340, 1-6, incorporated by reference. Micro- or nanocrystalline diamond films, see R. Rameshan, Thin Solid Films 1999, 340, 1-6, incorporated herein by reference, have superior mechanical characteristics (wear, hardness) with respect to amorphous carbon or diamond-like carbon (DLC) materials, but have higher surface roughness than the latter. DLC films are smoother and easier to integrate into more complex fabrication schemes but cannot be made highly conductive. Hence, micromachining techniques based on molding methods were developed to minimize the major problem of crystalline diamond films, that is, their surface roughness when used as a coating on tips made of other materials such as Si. An alternative is to use thin conformal films to cover probes made of other materials. This technique has the disadvantage that it increases the initial tip radius of the probes (10-20 nm) by the thickness of the diamond film (typically 70-100 nm to achieve full coverage of the substrate); thus, it results in much lower tip sharpness.

Typical commercial diamond-coated tips have radii in the 100-200 nm range. In particular cases, nanoscale roughness features can improve the radius of the contact area, but the general shape and aspect ratio of the probes is compromised. Molding of crystalline diamond works reasonably well, but leaves the growing surface of the diamond very rough, which is unsuitable to continue the integration with other, later-deposited layers and further processes.

### SUMMARY OF THE INVENTION

An object of the invention is to provide a new tip architecture consisting in the suspension of the tip from a symmetric 3-D array of membranes or diaphragms “hereafter a “3-D tip”) that enable vertical motion of the tip without lateral forces developed as in the case of tips integrated with cantilever beams as in conventional atomic force measurement (AFM) probes and other current tip array systems such as microelectromechanical system (MEMS) tip arrays for the millipide-type memory, or large tip arrays for large parallel fabrication of nanobiological dots using the dip-pen technique. The new monolithically integrated “3-D tip” structure described in this patent is substantially made of a material called ultrananocrystalline diamond (UNCD) developed in film form and previously patented by Argonne National Laboratory.

Another object of the invention is to provide a monolithically integrated “3-D tip” array of the type set forth and further including a heating element in communication therewith.

A final object of the invention is to provide a method of forming a single or a large array of “3-D tips” made of substantially all UNCD, wherein a substrate with a predetermined pattern therein is provided, depositing an oxide layer on at least a portion of the predetermined pattern, depositing a seed metallic layer of one or more of tungsten, molybdenum, titanium or other carbide-forming layer, depositing UNCD on the seed metallic layer and conforming to the predetermined pattern on the substrate followed by one or more of masking and/or etching and/or coating and/or selective removal and/or patterning and/or electroforming and/or lapping and/or polishing in any combination to form a molded monolithic UNCD structure having an integral tip and a 3-D array of membranes or a diaphragm.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a schematic representation of the steps to fabricate multiple 3-D tips;

FIG. 2 is a schematic representation of a 3-D tip.

### DESCRIPTION OF PREFERRED EMBODIMENT

UNCD films, as discussed by R. Rameshan, Thin Solid Films 1999, 340, 1-6; T. A. Friedmann, J. P. Sullivan, J. A. Knapp, D. R. Tallant, D. M. Follstaedt, D. L. Medlin, P. B. Mirkarimi, Appl. Phys. Lett. 1997, 71, 3820-3822; A. R. Kraus, O. Auciello, D. M. Gruen, A. Jayatissa, A. Sumant, J. Tucek, D. C. Mancini, N. Moldovan, A. Erdemir, D. Ersoy, M. N. Gardos, H. G. Busmann, E. M. Meyer, M. Q. Ding, Diamond Relat. Mater. 2001, 10, 1952-1961; a) H. D. Espinosa, B. C. Prorok, B. Peng, K.-H. Kim, N. Moldovan, O. Auciello, J. A. Carlisle, D. M. Gruen, D. C. Mancini, Exp. Mech. 2003, 43, 256-268; b) H. D. Espinosa, B. Peng, B. C. Prorok, N. Moldovan, O. Auciello, J. A. Carlisle, D. M. Gruen, D. C. Mancini, J. Appl. Phys. 2003, 94, 6076-6084; and A. Erdemir, C. Bindal, G. R. Fenske, C. Zuiker, R. Csencsits, A. R. Krauss, D. M. Gruen, Diamond Relat. Mater. 1996, 6, 31-47, all incorporated herein by reference, with grain sizes in the 2-5 nm range, retain most of the surface and bulk properties of crystalline diamond as well as the smoothness of the substrate. The material is deposited by microwave plasma-enhanced chemical vapor deposition (MPCVD) from an Ar—CH₄ (99:1) gas mixture or by other CVD techniques such as hot filament chemical vapor deposition technique (HFCVD) using H₂—CH₄ chemistry. Table 1 shows some of the remarkable properties of UNCD, as compared to other forms of diamond. The term ultrananocrystalline diamond (UNCD) is used to distinguish this material from microcrystalline diamond (MCD), nanocrystalline diamond (NCD), and diamond like carbon (DLC), since UNCD exhibits the smallest grain size (except for DLC films), and different morphology and properties than all the other forms of diamond mentioned above. Due to the small size of the grains, the ratio of grain-boundary atoms (which consist of a mixture of sp², sp³, and other forms of carbon bonding) to bulk atoms (sp³) is high, which leads to exceptional material properties such hardness and Young modulus similar to single crystal diamond, very low coefficient of friction, low force of adhesion, chemical inertness, relatively high fracture strength equal to or higher than that of single-crystal diamond and the ability to incorporate nitrogen into the grain boundaries which gives rise to greatly increased (up to 250 Ω⁻¹cm⁻¹) room temperature n-type conductivity.

TABLE 1
Characteristics of different diamond film.

| | Microcrystalline | Nanocrystalline | Ultrananocrystalline | Diamond-like carbon (DLC) | |
|---|---|---|---|---|---|
| | diamond (NCD) | diamond (MCD) | diamond (UNCD) ta-C | ta-H:C | |
| Growth species | CH₃* (H0) | CH₃* (H0) | C₂ | C | C |
| Crystallinity | columnar | mixed diamond and | equiaxed diamond | mixed diamond | amorphous |
| | | nondiamond | | and amorphous | |
| Grain size | ≈0.5–10 μm | 50–100 nm | 2–5 nm | variable - | |
| Surface | 400 nm–1 μm | 50–100 nm | 20–40 nm | 5–100 nm | 1–30 nm |
| roughness | | | | | |
| Electronic bonding | sp³ | up to 50% sp² | 2–5% sp² | up to 80% sp³ | up to |
| character | | (secondary phase) | (grain boundary) | | ≈40% sp³ |
| Hydrogen | <1% | <1% | <1% | <1% | 15–60% |
| content | | | | | |

The remarkable hardness of UNCD makes it the material of choice for contact-mode nanoprobe tips. Erdemir et al. measured wear rates on MCD films using a SiC pin-on-disk tribometer measurement technique. They found that MCD films exhibit wear rates from 0.48×10⁻⁶ to 55.0×10⁻⁶ mm³Nm⁻¹. By contrast, UNCD films exhibit a wear rate as low as 0.018×10⁻⁶ mm³Nm⁻¹. It was also found that the as-grown UNCD films have coefficient of friction roughly two orders of magnitude lower than those of MCD films of comparable thickness. The wear rate of a SiC pin rubbed against a UNCD film was found to be ≈4000 times lower than that of a SiC pin rubbed against an as-deposited MCD film.

The invention includes the fabrication of UNCD 3-D tips either isolated or in large arrays, which integrate solid or hollow tips made entirely of or substantially entirely of this material, both in nonconducting (undoped) and conducting (nitrogen-doped or boron-doped) states. The UNCD monolithic tips were characterized by SEMs and TEMs and their performances tested by imaging standard silicon samples. Their performance was satisfactory.

Molding is well known as a fabrication method for ultrasharp tips of a large variety of materials, including diamond, for which tip radii of 30 nm have been reported, see K. Okano, K. Hoshina, M. Iida, S. Koizumi, T. Inuzuka, Appl. Phys. Lett. 1994, 20, 2742-2744; and W. Scholtz, D. Albert, A. Malave, S. Werner, C. Mihalcea, W. Kulisch, E. Oesterschulze, Proc. SPIE 1997, 3009, 61-71, incorporated herein by reference.

Tip radii were limited by the geometrical precision of the pyramidal pit etched into silicon, and by the diamond deposition and seeding parameters. The ultimate shape of such a pyramidal pit in Si(100) results from many factors, which include the accuracy of crystallographic orientation/alignment, and the lithographic performances in providing optimum geometries for windows in the masking layer used for pyramidal etching. A slight increase in the window size in one direction results in the formation of a line-edge probe rather than a point-tip probe. The alignment, lithography, and etching processes are never perfect to the nanometer scale, therefore one expects line-edge probes to be always obtained, depending on how much magnification is used in observing the tip end.

In the inventive method, besides a sufficiently rigorous lithography (±0.1 μm) and care in alignment (better than ±1° for both flat-to-crystal and mask-to-flat alignment), an oxidation sharpening step, as is known in the art, has produced superior results. This step, as well as the additional sharpening due to constraints in the oxide growth in pyramidal pits, see P. N. Minh, O. Takahito, E. Masayoshi, Fabrication of Silicon Microprobes for Optical Near-Field Applications, CRC Press, Boca Raton, Fla., 2002, chap. 4, incorporated herein by reference, performed well in leading to single-point tip geometry.

The molding method has the general inconvenience that the tip is fabricated facing toward the substrate, thus requiring some microfabrication effort to reverse the probe cantilevers with respect to the handling chip body. Several methods have been reported for reversing the diamond tips, including: 1) building of a chip body by micromachining and gluing of a complementary silicon or glass wafer onto the tip-fabrication wafer; 2) fabricating tips and portions of the cantilevers on one wafer and gluing them onto cantilevers fabricated on other wafers (eventually, made of other materials), followed by releasing. These methods require aligned bonding procedures and a good resistance of the glue joint during the chip release and operation processes.

The processing steps employed to fabricate molded UNCD probes may be started with the formation of an oxide mask (thermal oxidation, 500 nm), which is patterned lithographically with square openings (12×12 μm), followed by KOH (30%, 80 degrees C.) etching of pyramidal pits in the Si(100) wafer. Several groups of different size squares and rectangles can be fabricated simultaneously with a mask such that a large variety of tip geometries could be obtained. A thermal oxidation sharpening process as is known in the art may follow at 900 degrees C. which results in a SiO₂ layer>1 μm in thickness on the [100] surface of the Si wafer and in the pit.

Following the oxidation sharpening step, a W, Mo, Ti or any other carbide-forming layer is deposited on the oxide layer to provide a high-density diamond nucleation layer to yield the ultra-smooth UNCD layer required for the atomically sharp diamond tips. The carbide-forming layer can be deposited by any of the physical vapor deposition techniques (e.g., sputtering, e-beam evaporation, or pulsed laser ablation) or chemical vapor deposition methods (e.g., atomic layer deposition or metalorganic chemical vapor deposition).

An ultrasonic seeding procedure can be applied with a 3-5 nm-grain diamond powder suspended in methanol (5 mgL⁻¹), to which the wafers can be exposed for 30 min or longer (to achieve high-density seeding), and rinsed with isopropanol, then ultrasonically cleaned in methanol for 5 min and dried. Other rinsing steps can be added as required to optimize the seeding process. Growth of the UNCD layer (0.5-1 μm thick) can be achieved by MPCVD in a methane-argon gas mixture, which also may contain nitrogen in the case of the N-doped films or a boron compound for b-doped films, or by using a hot filament chemical vapor deposition method with H₂—CH₄ chemistry. Next, an Al mask (80 nm) can be deposited by electron-beam evaporation or other vapor deposition method and patterned to define the membranes or diaphragms for the “3-D tip” structures, or other geometries. The pattern can be transferred into UNCD by reactive ion etching (RIE) with an oxygen plasma (30 mTorr, 50 sccm, 200 W), according to a process described in N. Moldovan, O. Auciello, A. V. Sumant, J. A. Carlisle, R. Divan, D. M. Gruen, A. R. Krauss, D. C. Mancini, A. Jayatissa, J. Tucek. Proceedings of the SPIE 2001 International Symposium on Micromachining and Microfabrication, San Francisco, Calif., Oct. 22-25, 2001, 4557, 288-298, and incorporated by reference, after which the Al mask can be removed by wet chemical etching. The oxide on the back side could be patterned with a mask for subsequent release of the structures. Removal of the Si substrate can be performed by KOH etching (30%, 80° C.), and the remaining oxide can be removed by a buffered HF solution (BHF).

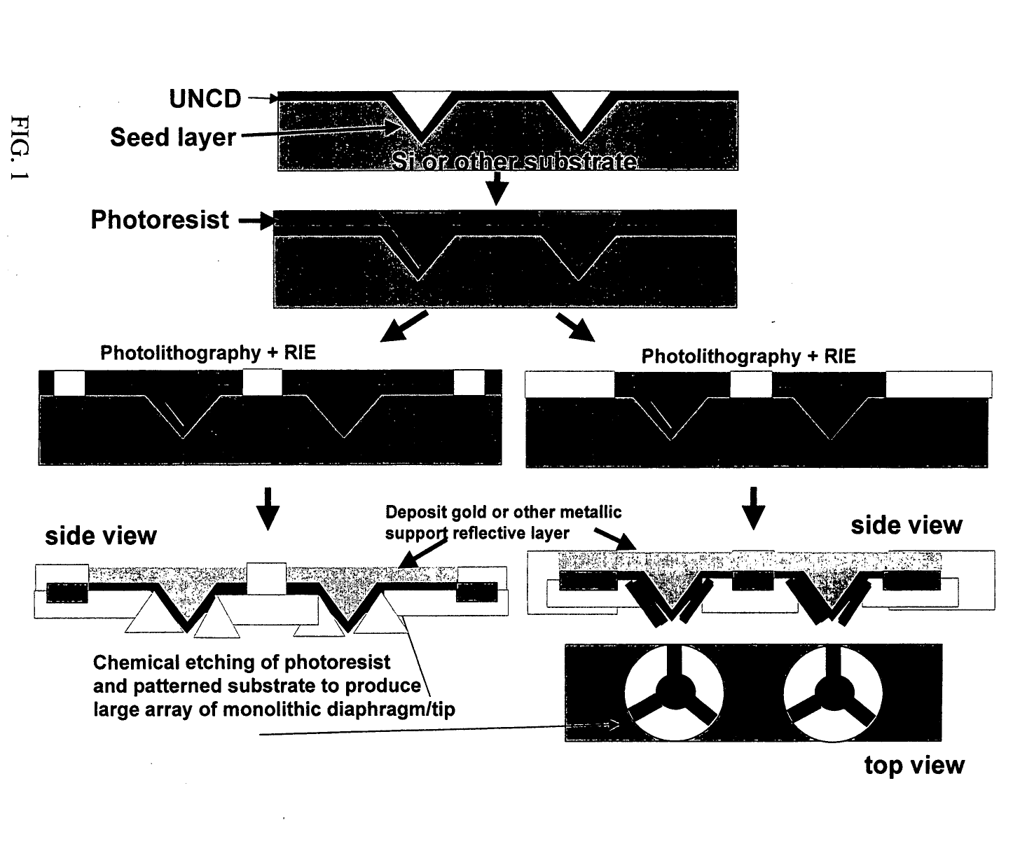

Referring to FIG. 1, there is illustrated a schematic flow chart for making one or more 3-D tips”.

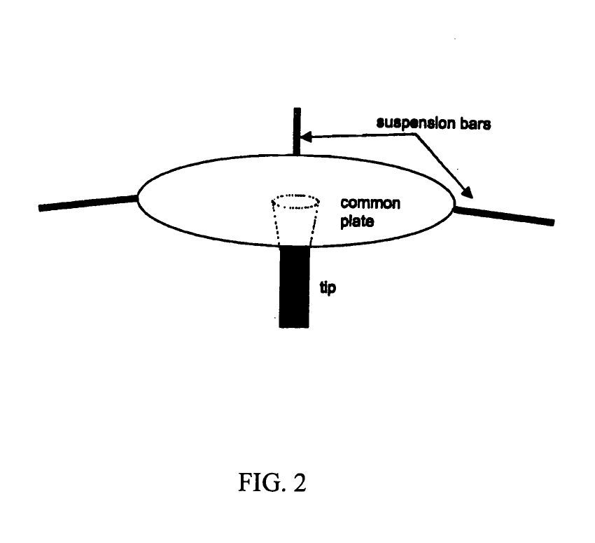

The probe of FIG. 2 is a 3-dimensional sensor, measuring forces along all three axes simultaneously, independently, and with high sensitivity. The thickness of the membranes or diaphragms in FIG. 2 (wherein only one is shown) may be greater than about 100 nm, while the support arms (suspension bars) may be three or more for a single diaphragm. If three support arms are used they are spaced 120 degrees apart; however, fewer support arms may be used. A normal approach of the tip to the sample is used, eliminating the tilt issue. The three-dimensional design also facilitates force calibration. The probe, including a nano-scale tip, is entirely fabricated out of ultrananocrystalline diamond (UNCD), which has far better mechanical and tribological properties as compared with silicon or silicon-based materials, providing this force sensor with unparalleled structural stiffness, robustness, strength, inertness, wear-resistance, and biochemical compatibility and tailor ability. Continued deposition of UNCD prior to deposit of the photoresist layer provides a solid polyhedron in the form of a pyramid. Any shape can be made by this method for either hollow or solid structures.

Examination of UNCD surface morphology reveals that film growth is achieved from seeding nanoparticles, which leads to clustering. As discussed in the context of UNCD strength, a large number of grains are present in each cluster and imperfections between clusters were observed in the form of voids. Growth of UNCD on ultrasonically seeded SiO₂ is more challenging than growth on Si; hence, cluster and void sizes generally tend to increase. Similar structures, but made of crystalline grains, have been observed in MCD films grown on sidewalls of pyramidal pits in Si. The nucleation of MCD grains and intergrain gap formation on tilted surfaces were linked by Scholtz et al. to the size of the diamond particles used in the ultrasonic seeding process. In their experiments, ultrasonic abrasion with 40-μm-diameter diamond particles produced minimal intergrain gaps on flat surfaces, while for pyramidal holes, the optimum diamond particle size for uniform coverage was found to be 1 μm. In our case, the role of film growth is taken by the diamond nanoparticles used in the seeding step, but the nucleation and growth obeys similar rules. A coral-like surface morphology can be observed using the process described herein.

It has been determined that SiO₂ is a more difficult nucleation medium than Si and results in poor UNCD film adhesion, especially in the case of doped UNCD, such as nitrogen or boron doped electrically conducting UNCD. Nonetheless, it is indispensable for maximum sharpening. To obviate this problem, W, Mo, Ti or any other carbide forming layer is deposited on the oxide layer before seeding. Tip radius has been measured between about 50 and 150 nm with tips made according to the present invention. In a variant of the processing sequence, an additional lithography step to selectively remove the oxide prior to the UNCD deposition from all areas, may be used except the pyramidal pits. For this purpose, a reversible (negative) photoresist (Shipley AZ5214E), through which the oxide was removed in buffered oxide etch (BOE), may be employed

UNCD films are grown using microwave plasma CVD OR HFCVD and is composed of 95% sp3-bonded carbon, with an extremely small grain size (3-5 nm) and very smooth surfaces, generally 10-20 nm. The mechanical, tribological and chemical properties of UNCD films are equivalent to that of single crystal diamond and therefore are ideally suited for such application. We have demonstrated the fabrication of monolithically integrated tip/cantilevers from UNCD, which involves first fabricating pyramidal etch pits on a silicon wafer by anisotropic etching of exposed regions in KOH. This is followed by the growth of SiO₂, deposition of the carbide-forming metallic layer, diamond seeding and finally growth of the UNCD thin film. Optical lithography is then used to produce metal masks on the UNCD film. Reactive ion etching (RIE) with an oxygen plasma is then used to define the 3-D force probe structures that are aligned so that the tip structure is located appropriately. The structures are then bonded to holders and released by etching the remaining silicon substrate. The 3-D force probes with integrated solid or hollow tips can be fabricated this way. Durability tests carried out on the tips to characterize their mechanical and tribological properties show that these tips exceed the performance of any commercially available AFM or any other tips.

As appreciated from the foregoing:

1) UNCD can be deposited at a temperature at low as 400° C., making this process more economical over the prior art, where tips made out of Si and Si₃N₄ need to be deposited at substrate temperatures of at least 600 degrees C. and above, and CVD-diamond where substrate temperatures of 800 degrees C. required.

2) Allowing 3-D force sensing allows fully quantitative, unambiguous measurements and mapping of the complete force vector of interaction between the tip and the sample. This is impossible to do with conventional AFM fixed-free cantilevers.

3) Direct normal contact between the tip and sample avoids the coupling of interaction forces normal and parallel to the sample.

4) Because of the superior intrinsic mechanical and tribological properties (very low friction, adhesion, and wear) of UNCD, these microstructures will have much higher resonance frequencies and quality factors than silicon or silicon nitride, and will be more sensitive for applications such as intermittent-contact AFM, non-contact AFM, magnetic resonance AFM, gravimetric detection of analytes.

5) Because of the superior tribological properties of UNCD compared with silicon and silicon nitride, these probes are extremely useful in applications including metrology, nano-machining, nanomanufacturing, and nanoscale data storage, where conventional tips wear out very quickly.

6) Because of the extremely high chemical and biological stability of UNCD, the tips can be functionalized with chemical or biological species that can then be used for bio/chemical interaction measurements and detection schemes, see Nature Publishing Group, Nature Materials/Advance Online Publication, DNA-Modified Nanocrystalline Diamond Thin-Films as Stable, Biologically Active Substances, 2002, Yang et al. pps. 1-5 and American Chemical Society, Surface Functionalization of ultrananocrystalline Diamond Films By Electrochemical Reduction of Aryldiazonium Salts, Wang et al., Langmuir 2004, Vol. 20, No. 26, 11450-11456.

7) Economically, production of such tips will be more viable since they can be fabricated in large quantities per wafer. This is particularly important since some companies produce “diamond tips” by attaching a single crystal diamond tip to a Si cantilever individually. These can have good wear resistance, but this process is costly and cumbersome, and does not provide the full benefit of having the monolithically integrated “3-D tip” described in this application.

8) Since UNCD can be deposited at a relatively low temperature (400° C.), diaphragms of the 3-D structures, with sensitive embedded electronic elements or thermally sensitive materials, such as piezoresistive cantilevers or cantilevers with built-in heating elements, can be coated without any risk of thermal damage to the existing diaphragm.

9) UNCD films can de doped easily with nitrogen or boron, making it electrically conductive. Therefore, a single tip can be used for multiple applications such as imaging, force mapping and electrical measurements (scanning capacitance microscopy, scanning tunneling microscopy).

10) The as-molded stress is very low, always less than 500 MPa and usually less than about 100 MPa, preventing undesirable cantilever, membrane, or diaphragm deflection.

11) Electrical elements such as, but not limited to, CMOS may be added to the monolithic (one piece or integral) UNCD along with, in any combination, or in lieu of a piezoelement such as but not limited to a piezoresistive element or a heating element or a chemically or biologically functionalized UNCD.

12) AFM probe tips have been fabricated with tip radius in the range of from about 50 to about 150 nm with surface roughness from about 20 to about 40 nm.

13) Monolithic AFM probes have been made of UNCD in a variety of configurations. Solid or hollow UNCD structures of almost any shape can be incorporated into a wide variety of monolithic UNCD devices as stated in paragraph 11 above.

14) Molded hollow or solid UNCD structures have been made with low as-molded stress with both electrically conducting and electrically insulating UNCD.

While the invention has been particularly shown and described with reference to a preferred embodiment hereof, it will be understood by those skilled in the art that several changes in form and detail may be made without departing from the spirit and scope of the invention.

The embodiments of the invention in which an exclusive property or privilege is claimed are defined as follows:

1. An 3-D tip measuring forces in three dimensions,
said 3-D tip including membranes or a diaphragm and a tip associated therewith, said membranes or diaphragm and said tip being substantially all UNCD.

2. The 3-D tip of claim 1, wherein said probe is monolithic.

3. The 3-D tip of claim 1, wherein said membranes and/or diaphragm are in communication with said tip.

4. The 3-D tip of claim 1, wherein said tip has a radius of less than about 150 nanometers (nm).

5. The 3-D tip of claim 1, wherein said tip has a radius in the range of from about 50 to about 150 nm.

6. The 3-D tip of claim 1, wherein said membranes and/or diaphragm have thickness greater than about 100 nm.

7. The 3-D tip of claim 1, wherein said tip has a surface roughness of less than about 40 nanometers (nm).

8. The 3-D tip of claim 1, wherein said tip has a surface roughness of less than about 20 nm.

9. The 3-D tip of claim 1, wherein said tip has a RMS surface roughness of less than about 11 nm.

10. The 3-D tip of claim 1, wherein said tip is made by molding and has an as-molded stress of less than about 500 MPa.

11. The 3-D tip of claim 1, wherein said tip is made by molding and has an as-molded stress of less than about 100 MPa.

12. The 3-D tip of claim 1, and further including a plurality of supports extending from said membranes or diaphragm and integral therewith.

13. The 3-D tip of claim 1, wherein said tip is a polyhedron.

14. The 3-D tip of claim 1, wherein said tip is a pyramid.

15. The 3-D tip of claim 1, wherein at least 95% of the UNCD has average grain sizes in the range of between about 2 and about 5 nm.

16. The 3-D tip of claim 1, wherein at least some of said UNCD is electrically conductive.

17. The 3-D tip of claim 1, wherein said tip is chemically or biologically functionalized.

18. The 3-D tip of claim 1, and further including an electrical element in communication therewith.

19. The 3-D tip of claim 1, and further including a piezoresistive element in communication therewith.

20. The 3-D tip of claim 1, and further including a heating element in communication therewith.

21. A 3-D tip simultaneously measuring forces in three dimensions,
said 3-D tip including UNCD membranes or diaphragm and tips,
said tip having a surface roughness of less than about 11 nm.

22. A method of forming a 3-D tip of substantially all UNCD, comprising providing a substrate with a predetermined pattern therein,
depositing an oxide layer on at least a portion of the predetermined pattern,
depositing one or more of W, Mo, Ti or a carbide-forming layer on the oxide layer,
depositing UNCD on the W, Mo, Ti, or a carbide forming layer and conforming to the predetermined pattern on the substrate followed by one or more of masking and/or etching and/or coating and/or selective removal and/or patterning and/or electroforming and/or lapping and/or polishing in any combination to form a molded monolithic UNCD structure having an integral tip and membranes and/or a diaphragm.
